(19) United States
(12) Patent Application Publication
(10) Pub. No.: US 2006/0224817 A1
(43) Pub. Date: Oct. 5, 2006

(54) NOR flash file allocation

(76) Inventor: Sunil R. Atri, Folsom, CA (US)

Correspondence Address: TROP PRUNER & HU, PC, 1616 S. VOSS ROAD, SUITE 750, HOUSTON, TX, 77057-2631, US

(21) Appl. No.: 11/096,492

(22) Filed: Mar. 31, 2005

(51) Int. Cl. G06F 12/00

(52) U.S. Cl. 711/103; 711/170

(57) ABSTRACT

An emulated file allocation table for a NOR flash memory may provide features that improve the performance or efficiency of the file allocation process. For example, the emulated file allocation table may include a slot or field which provides the information needed to convert from logical numbers to physical addresses. In some embodiments, this may reduce the demands on the system random access memory. In addition, the table may provide an entry which accommodates for deletion or replacement of sectors. In particular, it may provide a pointer for where to go in such circumstances. The provision of such a slot or field may reduce or eliminate the need to rewrite the file allocation table each time a cluster is replaced or deleted.

### BACKGROUND

This invention relates generally to flash memories.

Flash memories may include a file allocation table. The file allocation table lists a sequence of clusters that are part of a file using a next logical cluster number field. Thus, logical cluster numbers can be obtained for successive members of a file.

With NAND flash memories, when a change is to be made to a block, the entire block may be copied over to random access memory, the change made, and the entire block written back to the flash memory. Thus, in connection with file allocation tables for NAND flash memory, when a cluster in a file is deleted or replaced the corresponding information can be rewritten in the memory array.

Such operations are not feasible in NOR flash because of the time needed to replace the entire block. Thus, a problem arises in NOR flash file allocation because of the difficulty inherent in deletion and replace operations.

Often, NOR flash comes on a card form factor. The card form factor is recognized by operating systems, such as the Windows® operating system, like any other storage device including a disk drive. It is generally expected that the card form factor will be compliant with a file allocation table protocol which expects that the medium is readily re-writeable. However, in NOR flash, erasing blocks is time consuming and so operations expected by such a protocol may be less feasible in NOR flash memory.

Thus, there is a need for better ways to handle file allocation in NOR flash devices.

### BRIEF DESCRIPTION OF THE DRAWINGS

FIG. 1 is a system depiction in accordance with one embodiment of the present invention.

FIG. 2 is a depiction of the logical and physical data storage indicating how a file allocation table works in one embodiment of the present invention;

FIG. 3 shows the arrangement of data in the logical cluster number to physical address slot in the table in FIG. 1 in accordance with one embodiment of the present invention;

FIG. 4 is a flow chart for software for populating the file allocation table in accordance with one embodiment of the present invention;

FIG. 5 is a flow chart for software for handling a cluster replace or deletion in one embodiment; and

FIG. 6 is a flow chart for finding the next cluster when retrieving a file in accordance with one embodiment of the present invention.

### DETAILED DESCRIPTION

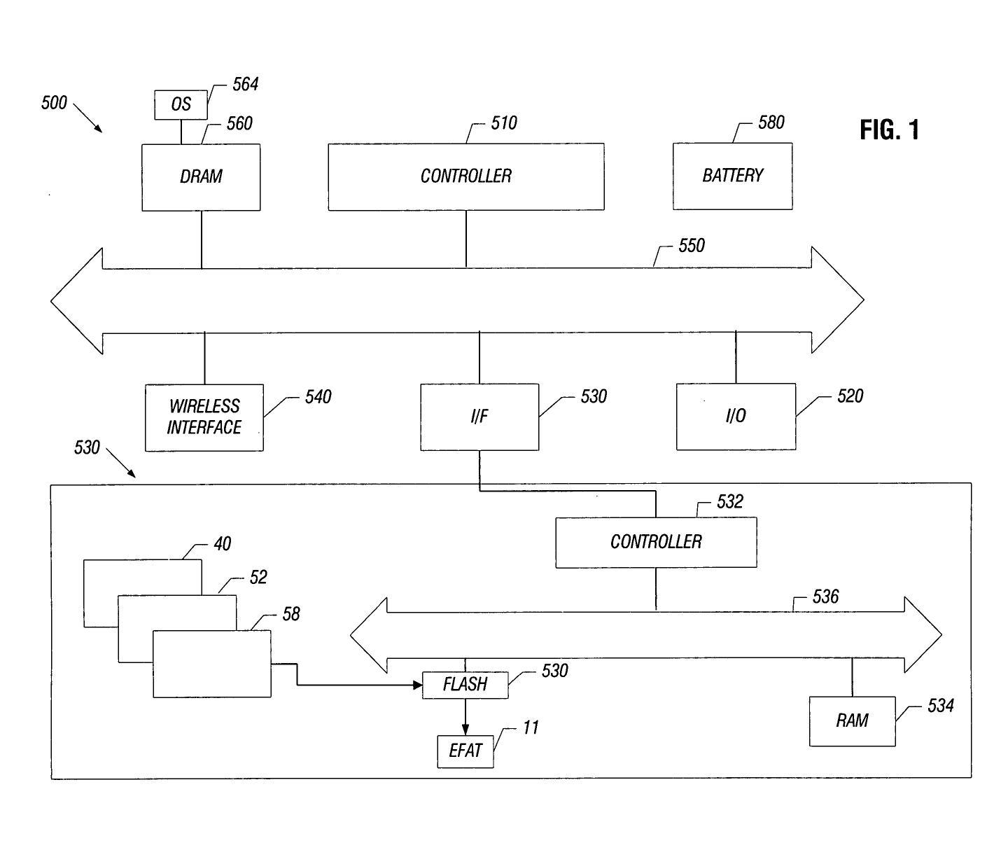

Referring to FIG. 1, a processor-based system 500 may include a bus 550 which communicates with a controller 510, which may be microcontroller, one or more microprocessors, or a digital signal processor, as a few examples. In some embodiments, the system 500 may be battery powered via a battery 580. However, the present invention is not limited to mobile devices.

A system memory or dynamic random access memory (DRAM) 560 may be coupled to the bus 550. The DRAM 560, after system initialization, may store an operating system (OS) 564, such as the Windows® operating system.

A variety of input/output (I/O) devices 520 may be coupled to the bus 550. The I/O devices 520 may be conventional devices such as a touch screen, a display, a mouse, a keyboard, or the like. A wireless interface 540 may also be coupled to the bus 550. The wireless interface 540 may enable cellular or other communications between the system 500 and other devices. The wireless interface 540, in some embodiments, may include a dipole antenna.

The system 500 may include a NOR flash memory 530. The NOR flash memory 530 may store its own emulated file allocation table 11. The flash memory 530 may be in a card from factor in one embodiment that plugs into an interface (I/F) 531 coupled to the bus 550. The memory 530 includes a controller 532 coupled by a bus 536 to the actual flash memory 530 and a random access memory (RAM) 534. An emulated file allocation table 11 may be stored on the flash memory 530. Also stored on the flash memory 530 is software 40, 52, and 58 for implementing the emulated file allocation table 11. However, upon initialization, the emulated file allocation table 11 and the software 40, 52, and 58 may be executed from the random access memory 534.

In accordance with some embodiments of the present invention, the memory 530 may act as a non-volatile storage to store code for implementing a variety of functions, including message storage for wireless communications, as one example. However, the scope of the present invention is not in any way limited to wireless embodiments.

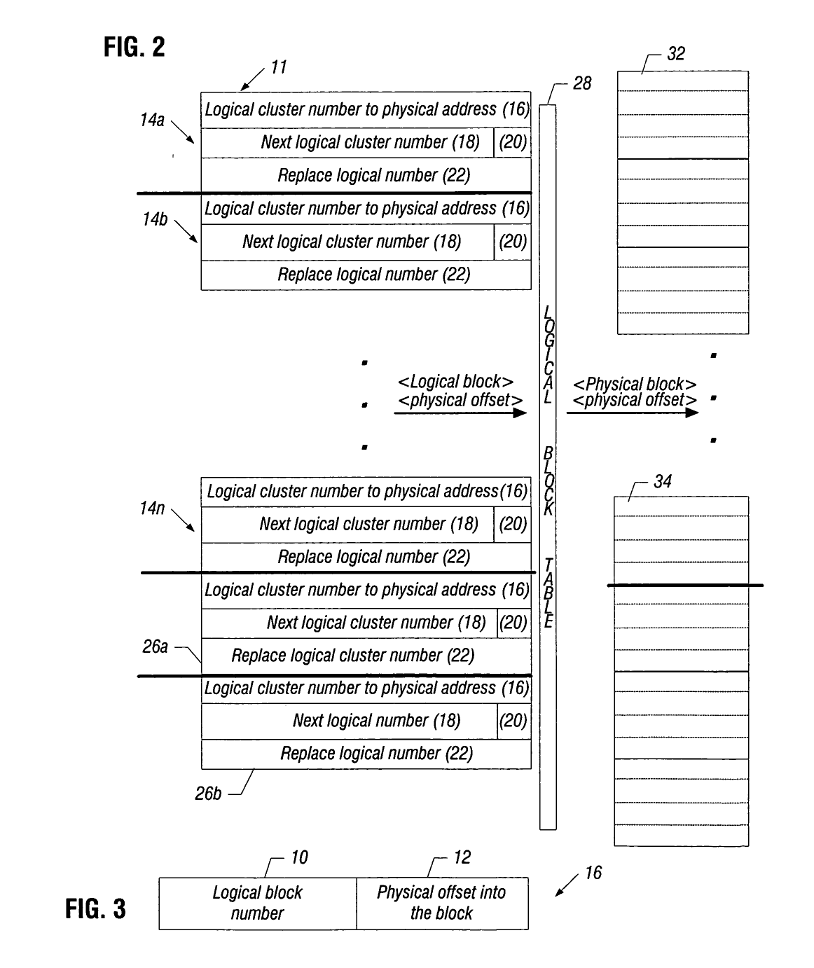

Referring to FIG. 2, an emulated file allocation table 11 may operate with the operating system 564. When the operating system 564 tries to read a file allocation table on the NOR flash memory 530, the NOR flash memory 530 constructs the emulated file allocation table 11 on the fly in its RAM 534 and provides the emulated file allocation table 11 to the system 500.

Similarly, when a write command comes in to a file allocation table on the memory 530, the emulated file allocation table 11 updates a linked list of clusters associated with a file without rewriting the table 11. The interfacing between the operating system 564 and the flash memory 530 is handled by software running on the controller 532.

The table 11 may be configured to enable clusters of memory locations, representing a file, within blocks of memory locations to be found. Bits or cells may be organized into sectors which, in turn, are organized into addressable groups of contiguous sectors called clusters which, in turn, may be organized into blocks.

Each cluster has both a physical address and a logical address called the logical cluster number. The logical cluster number may be translated into a physical address through the table 11 in accordance with some embodiments of the present invention. Each block includes an initial group of sectors addressable as sectors rather than clusters, which permanently identify the logical block numbers of the block.

Initially, the logical block number and the physical block number are the same. However, reclaims of unused, invalid sectors result in movement of data such that, eventually, logical and physical addresses diverge. The initial sectors on the block also record which sectors or clusters are still valid. Each time a new cluster is added to a file, an old cluster may be marked as invalid in the block's initial sectors. The correspondence between logical and physical addresses may be maintained in the logical block table 28.

Thus, each cluster may be associated with a set of slots 14 in the emulated file allocation table 11. For example, the set of slots 14a for a particular cluster include a logical cluster number to physical address slot 16, a next logical cluster number slot 18, a replace bit 20, and a replace logical number slot 22. This sequence of slots 16-22 repeats for the clusters 14a-14n that constitute a file.

The sets of slots 14 constitute the advertised pool of available clusters. There are additional clusters 26, that are identified similarly, which are a part of a reserved pool of clusters 26a-26n. The reserved pool of clusters 26 may be equal to or greater than the reserved number of clusters to support rewrites and reclaims. Thus, a number of reserved clusters 26 may be provided in the same format just described for the advertised pool of clusters 14.

Of course, the emulated file allocation table 11 points to the physical advertised pool of data clusters 32 and the physical reserved pool of clusters 34. In point of fact, the emulated file allocation table 11 enables the physical addresses of the clusters 32 and 34 to be located in a sequential fashion to retrieve a file.

The logical cluster number to physical address slot 16 is depicted in more detail in FIG. 3. The slot 16 includes the logical block number 10 and the corresponding physical offset 12 of the cluster into the block. Thus, the logical cluster to physical address slot 16 provides information that allows a physical cluster to be found quickly without using up random access memory cycles to convert the logical block number into a physical offset into the block. The correct physical block number of the cluster can be located using the logical block table 28.

The next logical cluster number slot 18 points to the next cluster in a chain of clusters. Thus, a series of clusters may be accessed one after the other. Associated with the slot 18 is a replace bit 20. If the next logical cluster number slot 18 is populated, this bit 20 is ignored. If the slot 18 is not populated, this bit 20 indicates an end of the file being accessed and, particularly, that there are no more clusters in the chain.

The replace logical number slot 22 indicates the location of a deleted or replaced cluster. Through the use of the replace logical number slot 22, entries may be accessed in a chain and it is not necessary to force a rewrite of the table each time a cluster is deleted or replaced. In other words, simply populating the slot 22 may enable a cluster that is part of a chain to continue to be accessed even if it is replaced or deleted. The use of the slot 22 may also reduce the need to rewrite the emulated file allocation table 11 each time a cluster is replaced or deleted.

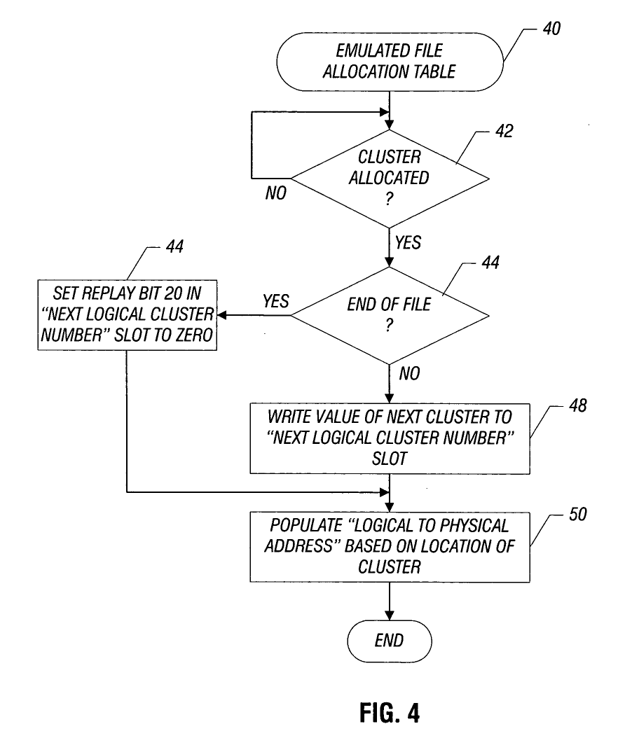

Referring to FIG. 4, the software 40 may be utilized to set up the emulated file allocation table 11 in some embodiments. Initially, a check at diamond 42 determines whether the next cluster in a chain is allocated. In other words, a check determines whether another cluster is to be allocated as part of a chain that makes up an accessible file. A check at diamond 44 determines whether the next cluster is the end of the file. If so, the replace bit 20 is set to zero in association with the next logical cluster number slot 18 for this next cluster. If the next allocated cluster is not the end of the file, then the value of the next cluster is written to the “next logical cluster number slot 18” as indicated in block 48.

Then, in either case, the logical to physical address slot 16 is populated based on the logical and physical locations of the next cluster, the processing ends until another cluster is allocated and then the flow repeats. In this way, the file allocation table is progressively built up cluster by cluster in a sequential fashion and within the file allocation table chains of sectors may be established.

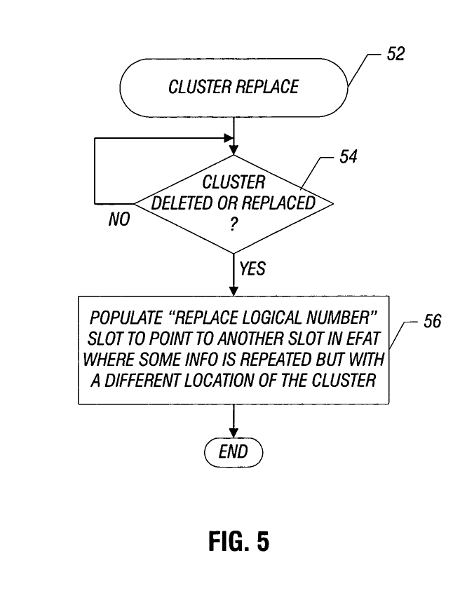

Moving to FIG. 5, the software 52 adjusts the emulated file allocation table 11 to accommodate for when a cluster in the table 11 is replaced or deleted. Advantageously, the software 52 enables a replace or delete to be handled without entirely rewriting the file allocation table.

When a cluster is to be updated, the table 11 grows in the reserved pool of clusters 26. An entry is added to the linked list and the next logical cluster number is added to a slot for the new cluster in the reserved pool 26. Thus the next logical cluster number slot 18 for the old cluster (that has been updated) now points to a cluster represented by a slot in the reserved pool 26.

To update a cluster, the old sector is marked invalid in the appropriate area reserved for that purpose at the top of each block. A space is found for the new data to be stored. An entry is made in the linked list for the new cluster. The data is written into the new cluster and the data is marked valid in the appropriate area at the top of the block. Then all that is needed is to provide a pointer in the table 11 to replace the old cluster with the new one in the table's linked list.

A check at diamond 54 determines whether a cluster delete or replace has occurred. If so, the replace logical number slot 22 is populated to point to another slot in the reserved pool of sectors 26 where the same information is repeated, but with a different location of the cluster. In other words, the chain may be maintained, even in this situation, without requiring the whole file allocation table to be rewritten.

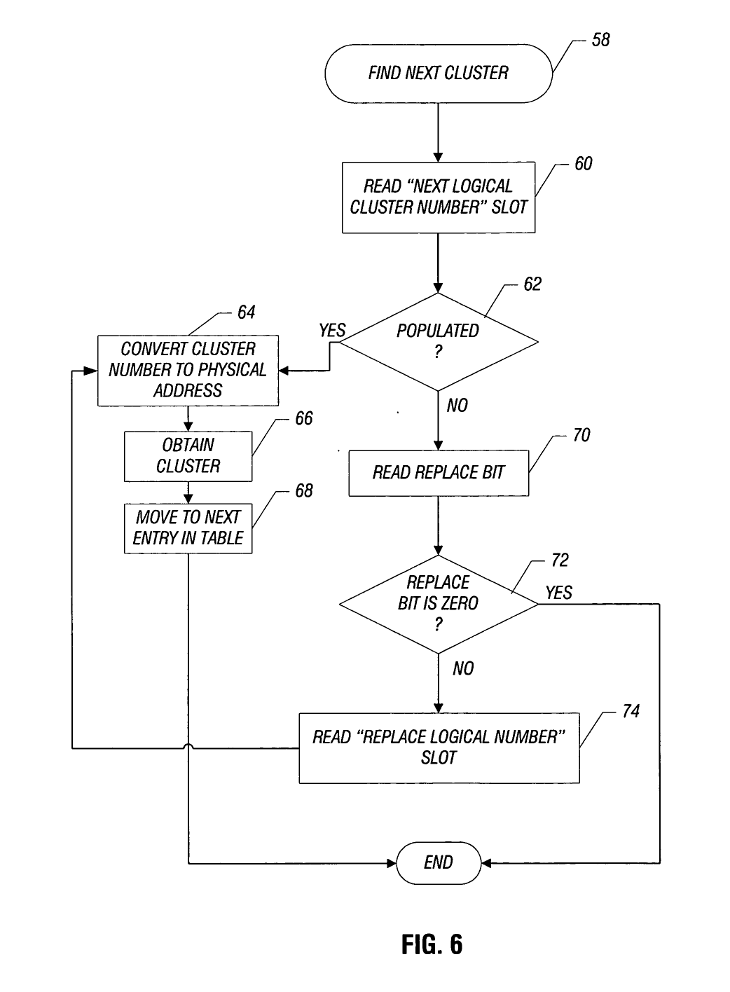

The implementation of a file access, cluster by cluster, is indicated in the find next cluster software 58 of FIG. 6. Initially, the next logical cluster number slot 18 is read, as indicated in block 60, to move from one cluster to the next in a chain. If the next logical cluster number slot 18 is populated, as determined in diamond 62, the current cluster physical address is obtained using the logical cluster number to physical address slot 16 as indicated in block 64. The cluster is obtained, as indicated in block 66, and the flow moves on to the next entry in the chain in the emulated file allocation table 11 as indicated in block 68.

If the next logical cluster number slot 18 is not populated, then the replace bit 20 is read as indicated in block 70. If the replace bit 20 is zero, as determined in diamond 72, the flow ends since the end of the file has been reached. Otherwise, the replace logical number slot 22 is read (block 74) to find the next slot in the sequence which has been interrupted by a delete or replace. Once that logical number is found, the steps indicated in blocks 64-68 are followed as described previously.

In accordance with some embodiments of the present invention, the utilization of random access memory may be more efficient because it is not necessary to use the flash memory to convert from logical to physical addresses. In addition, the need to rewrite the file allocation table on a replace or delete may be reduced and/or even avoided, in some embodiments, through the use of a slot within the file allocation table that accommodates for such changes.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
using a random access memory to allocate files for a NOR flash memory array.

2. The method of claim 1 including indicating the location of a deleted or replaced cluster.

3. The method of claim 1 including providing a slot in a table in said random access memory to give a logical block number and an associated physical offset into the block.

4. The method of claim 3 including providing a slot in said table which indicates the next logical cluster number and also indicates that the cluster has been replaced or deleted.

5. The method of claim 3 including providing in said table a slot which indicates the logical cluster to physical address translation.

6. The method of claim 1 including developing the file allocation table on request from an operating system.

7. The method of claim 6 including creating a linked list of clusters in said random access memory.

8. The method of claim 3 including populating a slot in said table to point to another slot in the table where the same information is repeated but with a different location of the cluster when a cluster has been deleted or replaced.

9. The method of claim 8 including using a slot in said table to find the next cluster in a chain of clusters making up a file.

10. The method of claim 9 including using another slot in said table to indicate where to find a cluster corresponding to a deleted or replaced cluster.

11. An article comprising a medium storing instructions that, if executed, enable a processor-based system to:
allocate clusters to files stored in a NOR flash memory array without requiring rewriting of said array when a cluster is replaced.

12. The article of claim 11 further storing instructions that, if executed, enable a processor-based system to indicate the location of a deleted or replaced cluster.

13. The article of claim 11 further storing instructions that, if executed, enable a processor-based system to provide a slot in a table stored outside of said array, said table to give a logical block number and an associated physical offset into a block.

14. The article of claim 11 further storing instructions that, if executed, enable a file allocation table to be built upon request of an operating system for a file allocation table.

15. The article of claim 14 further storing instructions that, if executed, enable the file allocation table to be built in a random access memory separate from the NOR flash memory array.

16. The article of claim 15 further storing instructions that, if executed, enable the processor-based system to create a link list of clusters in said random access memory.

17. A flash memory comprising:
a controller;
a flash memory array coupled to said controller; and
a random access memory coupled to said flash memory array and said controller, said controller to generate a file allocation table stored in said random access memory.

18. The memory of claim 17, said controller to generate said file allocation table in said random access memory upon request of an operating system for a file allocation table.

19. The memory of claim 17 wherein said controller to allocate clusters to files stored in said flash memory array without rewriting of said flash memory array.

20. The memory of claim 17 wherein said controller to indicate the location of a deleted or replaced cluster.

21. The memory of claim 20, said controller to provide a slot in said file allocation table that gives a logical block number and an associated physical offset into the block.

22. The memory of claim 17, said controller to build the file allocation table to provide a slot which indicates the next logical cluster number and also indicates that a cluster has been replaced or deleted.

23. The memory of claim 17 wherein said table includes a slot that indicates the logical cluster to physical address translation.

24. The memory of claim 23 wherein said controller to create a link list of clusters in said random access memory.

25. The memory of claim 17 wherein said controller to populate a slot in said table to point to another slot in the table where the same information is repeated but with a different location of the cluster when a cluster has been deleted or replaced.

26. The memory of claim 17 wherein said controller to use a slot in said table to find the next cluster in a chain of clusters making up a file.

27. A system comprising:
a processor;
a wireless interface coupled to said processor; and
a flash memory coupled to said processor, said flash memory including a controller, a flash memory array, and a random access memory coupled to said controller, said random access memory to store a file allocation table generated upon request of an operating system for a file allocation table.

28. The system of claim 27 wherein said wireless interface includes a dipole antenna.

29. The system of claim 27 wherein said controller to allocate clusters to files stored in said flash memory array without requiring a rewriting of the array when a cluster is replaced.

30. The system of claim 27 wherein said flash memory to create a link list of clusters in said random access memory.
